(19) United States
(12) Patent Application Publication
(10) Pub. No.: US 2025/0360670 A1
(43) Pub. Date: Nov. 27, 2025

(54) METHOD OF MANUFACTURING THREE-DIMENSIONAL MODELING OBJECT

(71) Applicant: SEIKO EPSON CORPORATION, Tokyo (JP)

(72) Inventors: Tatsuya TERAMOTO, SHIOJIRI-SHI (JP); Taki HASHIMOTO, SHIOJIRI-SHI (JP)

(73) Assignee: SEIKO EPSON CORPORATION, Tokyo (JP)

(21) Appl. No.: 19/215,301

(22) Filed: May 21, 2025

(30) Foreign Application Priority Data
May 24, 2024 (JP) 2024-084622

(51) Int. Cl. B33Y 10/00; B33Y 50/02

(52) U.S. Cl. CPC B29C 64/106; B33Y 10/00; B33Y 50/02

(57) ABSTRACT

A method of manufacturing a three-dimensional modeling object includes a first stacking step for stacking an n-th layer, at least one step of a temperature measurement step for measuring a temperature distribution of the n-th layer and a temperature prediction step for predicting a temperature distribution of the n-th layer, a data generation step for generating or correcting the modeling data relating to an n+1-th layer, based on the temperature distribution of the n-th layer, and a second stacking step for stacking the n+1-th layer, based on the modeling data that relates to the n+1-th layer, wherein the n-th layer includes a first region and a second region, the first region is a region having a temperature lower than the second region, and, in the data generation step, the modeling data relating to the n+1-th layer is generated or corrected.

The present application is based on, and claims priority from JP Application Serial Number 2024-084622, filed May 24, 2024, the disclosure of which is hereby incorporated by reference herein in its entirety.

### BACKGROUND

### 1. Technical Field

The present disclosure relates to a method of manufacturing a three-dimensional modeling object.

### 2. Related Art

JP-A-2006-192710 discloses a technique of creating a three-dimensional object by extruding a melted thermo-plastic material onto a base from an extrusion nozzle that performs scanning according to pre-set shape data and further stacking a melted material on the material cured on the base.

There has been desired a technique that can improve quality of a three-dimensional modeling object modeled by stacking layers.

### SUMMARY

According to a first aspect of the present disclosure, a method of manufacturing a three-dimensional modeling object is provided. The method of manufacturing a three-dimensional modeling is a method of manufacturing a three-dimensional modeling object, the method being executed to model a three-dimensional modeling object by ejecting a modeling material from an ejection unit of a three-dimensional modeling device and stacking a plurality of layers according to modeling data for modeling the three-dimensional modeling object layer by layer, the modeling data being generated based on shape data indicating a shape of the three-dimensional modeling object, the method including a first stacking step for stacking an n-th layer by ejecting the modeling material from the ejection unit, where n is a freely-selected integer equal to or greater than one, at least one step of a temperature measurement step for measuring a temperature distribution of the n-th layer and a temperature prediction step for predicting a temperature distribution of the n-th layer, a data generation step for generating or correcting the modeling data relating to an n+1-th layer, based on the temperature distribution of the n-th layer, and a second stacking step for stacking the n+1-th layer by ejecting the modeling material from the ejection unit, based on the modeling data that is generated or corrected and relates to the n+1-th layer, wherein the n-th layer includes a first region and a second region, the first region is a region having a temperature lower than the second region, and, in the data generation step, the modeling data relating to the n+1-th layer is generated or corrected so that the modeling material is stacked in the first region before being stacked in the second region.

### BRIEF DESCRIPTION OF THE DRAWINGS

FIG. 1 is an explanatory diagram illustrating a schematic configuration of a three-dimensional modeling system of a first embodiment.

FIG. 2 is a perspective view illustrating a schematic configuration of a screw.

FIG. 3 is a schematic plan view of a barrel.

FIG. 4 is an explanatory diagram schematically illustrating a state in which a three-dimensional modeling device models a three-dimensional modeling object.

FIG. 5 is an explanatory diagram illustrating a schematic configuration of an information processing device.

FIG. 6 is a flowchart of modeling processing.

FIG. 7 is a diagram illustrating an example of a nozzle movement path contained in modeling data that is generated in step S40 and relates to an n+1-th layer.

FIG. 8 is a diagram illustrating another example of the nozzle movement path contained in the modeling data that is generated in step S40 and relates to the n+1-th layer.

FIG. 9 is diagram illustrating an example of the nozzle movement path contained in the modeling data that is corrected in step S90 and relates to the n+1-th layer.

FIG. 10 is diagram illustrating another example of the nozzle movement path contained in the modeling data that is corrected in step S90 and relates to the n+1-th layer.

FIG. 11 is a diagram illustrating an example of a nozzle movement path contained in modeling data that is generated in step S40 in modeling processing and relates to an n+1-th layer in a second embodiment.

FIG. 12 is diagram illustrating an example of the nozzle movement path contained in the modeling data that is corrected in step S90 in the modeling processing and relates to the n+1-th layer in the second embodiment.

FIG. 13 is a flowchart of modeling processing in a third embodiment.

FIG. 14 is a diagram illustrating an example of a movement path of a nozzle 61, the movement path being contained in modeling data that is generated in step S41 and relates to an n+1-th layer.

FIG. 15 is a diagram illustrating an example of the movement path of the nozzle 61, the movement path being contained in the modeling data that is corrected in step S91 and relates to the n+1-th layer.

FIG. 16 is a flowchart of modeling processing in a fourth embodiment.

FIG. 17 is a flowchart of modeling processing in a fifth embodiment.

FIG. 18 is a flowchart of modeling processing in a sixth embodiment.

FIG. 19 is a flowchart of modeling processing in a seventh embodiment.

FIG. 20 is a flowchart of modeling processing in an eighth embodiment.

### DESCRIPTION OF EMBODIMENTS

### A. First Embodiment

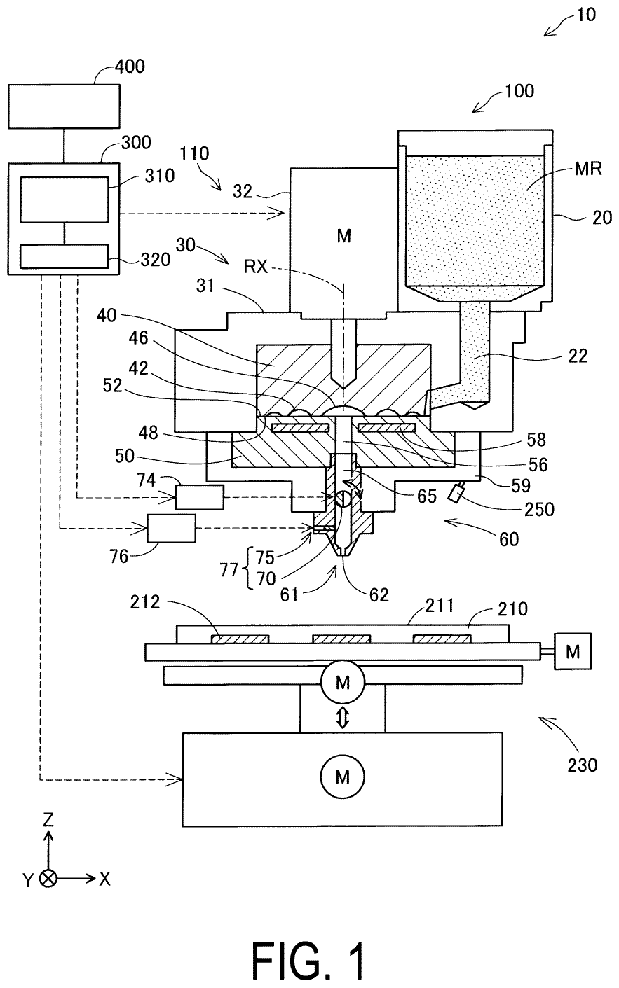

FIG. 1 is an explanatory diagram illustrating a schematic configuration of a three-dimensional modeling system 10 of a first embodiment. FIG. 1 illustrates arrows representing X, Y, and Z directions orthogonal to one another. The X direction and the Y direction are directions parallel to a horizontal plane. The Z direction is a direction parallel to a vertical direction. The X, Y, and Z directions in FIG. 1 and the X, Y, and Z directions in the other drawings represent the same directions. When orientation is specified, positive and negative signs are used together to represent directions, where “+” represents a positive direction, which is a direction represented by the arrow, and “−” represents a negative direction, which is opposite to the direction represented by the arrow.

The three-dimensional modeling system 10 includes a three-dimensional modeling device 100 and an information processing device 400. The three-dimensional modeling device 100 of the embodiment is a device that models a three-dimensional modeling object by a material extrusion method. The three-dimensional modeling device 100 includes a control unit 300 that controls each unit of the three-dimensional modeling device 100. The control unit 300 and the information processing device 400 are coupled to communicate with each other.

The three-dimensional modeling device 100 includes a modeling unit 110 that generates and ejects a modeling material, a stage 210 for modeling that serves as a base for a three-dimensional modeling object, a movement mechanism 230 that controls an ejection position of the modeling material, and a temperature measurement unit 250 that measures a temperature distribution of the modeling material ejected onto the stage 210.

Under control of the control unit 300, the modeling unit 110 ejects the modeling material, which is obtained by plasticizing a solid-state material, onto the stage 210. The modeling unit 110 includes a material supply unit 20 that serves as a supply source of a raw material before being converted into the modeling material, a plasticizing unit 30 that converts the raw material into the modeling material, and an ejection unit 60 that ejects the modeling material.

The material supply unit 20 supplies, to the plasticizing unit 30, a raw material MR for generating the modeling material. For example, the material supply unit 20 is configured by a hopper. The raw material MR in a pellet form or a powder form is stored in the material supply unit 20. Examples of the raw material MR include thermoplastic resins such as a polypropylene (PP) resin, a polyethylene (PE) resin, and a polyacetal (POM) resin. In the lower part of the material supply unit 20, a communication path 22 that couples the material supply unit 20 and the plasticizing unit 30 to each other is provided. The material supply unit 20 supplies the raw material MR to the plasticizing unit 30 via the communication path 22.

The plasticizing unit 30 plasticizes at least a part of the raw material MR supplied from the material supply unit 20, generates the modeling material in a paste form having fluidity, and guides the modeling material to the ejection unit 60. Herein, “plasticization” is a concept that includes melting, and refers to changing a solid into a state with fluidity. Specifically, for a material that undergoes glass transition, plasticization refers to raising a temperature of the material above the glass transition point. For a material that does not undergo glass transition, plasticization refers to raising a temperature of the material above the melting point. The plasticizing unit 30 includes a screw 40, a screw case 31, a driving motor 32, and a barrel 50.

The screw 40 is accommodated in the screw case 31. The upper surface side of the screw 40 is coupled to the driving motor 32. The screw 40 is rotated in the screw case 31 by a rotation driving force generated by the driving motor 32. An axial direction of a rotary axis RX of the screw 40 is a direction along the Z direction. The rotary speed of the screw 40 is controlled by the control unit 300 controlling the rotary speed of the driving motor 32. Note that the screw 40 may be driven by the driving motor 32 via a speed reducer. The screw 40 is also referred to as a rotor or a flat screw.

The barrel 50 is installed on the −Z direction side of the screw 40. A counter surface 52 being an upper surface of the barrel 50 faces a groove formation surface 48 being a lower surface of the screw 40. At the center of the barrel 50, a communication hole 56 that communicates with a flow path 65 of the ejection unit 60 is formed. Inside the barrel 50, a plasticizing heater 58 is provided. A temperature of the plasticizing heater 58 is controlled by the control unit 300.

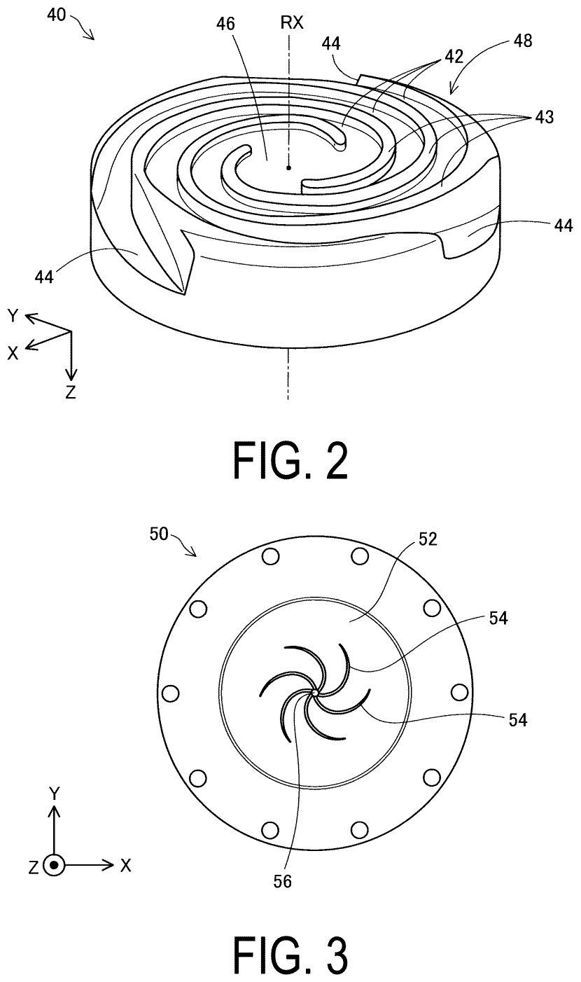

FIG. 2 is a perspective view illustrating a schematic configuration of the screw 40. The screw 40 has a substantially columnar shape whose length in a direction along the rotary axis RX is smaller than its length in a direction perpendicular to the rotary axis RX. In the groove formation surface 48, a spiral groove 42 is formed around a center portion 46. The groove 42 communicates with a material inlet 44 formed in a side surface of the screw 40. The material supplied from the material supply unit 20 is supplied to the groove 42 through the material inlet 44. The groove 42 is formed by being separated by a protrusion portion 43. FIG. 2 illustrates an example in which three grooves 42 are formed. However, the number of grooves 42 may be one, two, or more. Note that the groove 42 is not limited to a spiral shape, and may be a helical shape, an involute curved shape, or a shape extending in an arc from the center portion 46 toward the outer periphery.

FIG. 3 is a schematic plan view of the barrel 50. Around the communication hole 56 in the counter surface 52, a plurality of guide grooves 54 are formed. Each of the guide grooves 54 includes one end coupled to the communication hole 56, and extends spirally from the communication hole 56 toward the outer periphery of the counter surface 52. Note that the one end of the guide groove 54 may not be coupled to the communication hole 56. Further, the guide groove 54 may not be formed in the barrel 50.

The material supplied into the groove 42 of the screw 40 is plasticized in the groove 42 by rotation of the screw 40 and heating of the plasticizing heater 58, flows along the groove 42, and is guided as the modeling material to the center portion 46 of the screw 40. The modeling material in a paste form exerting fluidity flows into the center portion 46, and is supplied to the ejection unit 60 via the communication hole 56. Note that, in the plasticizing unit 30, not all types of substances constituting the modeling material may not be plasticized. The modeling material may be converted into a state having fluidity as a whole by plasticizing at least some types of substances constituting the modeling material.

The ejection unit 60 illustrated in FIG. 1 includes a nozzle 61 that ejects the modeling material, the flow path 65, which is provided between the screw 40 and a nozzle opening 62, for the modeling material, and an ejection control unit 77 that controls ejection of the modeling material.

The nozzle 61 is coupled to the communication hole 56 of the barrel 50 via the flow path 65. The nozzle 61 ejects the modeling material, which is generated in the plasticizing unit 30, from the nozzle opening 62 at the distal end toward the stage 210.

The ejection control unit 77 includes an ejection adjustment unit 70 that opens and closes the flow path 65 and a suction unit 75 that sucks and temporarily stores the modeling material.

The ejection adjustment unit 70 is provided inside the flow path 65, and rotates inside the flow path 65 to change an opening degree of the flow path 65. In the embodiment, the ejection adjustment unit 70 is configured by a butterfly valve. Under control of the control unit 300, the ejection adjustment unit 70 is driven by a first driving unit 74. For example, the first driving unit 74 is configured by a stepping motor. The control unit 300 controls a rotation angle of the butterfly valve by using the first driving unit 74. With this, a flow rate of the modeling material flowing from the plasticizing unit 30 to the nozzle 61, in other words, an ejection amount of the modeling material ejected from the nozzle 61 can be adjusted. The ejection adjustment unit 70 is capable of adjusting an ejection amount of the modeling material, and is also capable of controlling an on/off state of the outflow of the modeling material.

The suction unit 75 is coupled between the ejection adjustment unit 70 and the nozzle opening 62 in the flow path 65. The suction unit 75 temporarily sucks the modeling material remaining in the flow path 65 while ejection of the modeling material from the nozzle 61 is stopped. With this, a stringing phenomenon where the modeling material drips like a thread from the nozzle opening 62 is suppressed. In the embodiment, the suction unit 75 is configured by a plunger. Under control of the control unit 300, the suction unit 75 is driven by a second driving unit 76. For example, the second driving unit 76 is configured by a stepping motor, a rack-and-pinion mechanism that converts a rotation force of a stepping motor into translational motion of a plunger, or the like.

The stage 210 is arranged at a position facing the nozzle opening 62 of the nozzle 61. The three-dimensional modeling device 100 ejects the modeling material from the nozzle 61 onto a modeling surface 211 being an upper surface of the stage 210, and stack layers. With this, the three-dimensional modeling object is modeled. The stage 210 is provided with a stage heater 212 for preventing the modeling material ejected onto the stage 210 from being rapidly cooled. A temperature of the stage heater 212 is controlled by the control unit 300.

The movement mechanism 230 changes the relative position between the nozzle 61 and the stage 210. In the embodiment, the movement mechanism 230 moves the stage 210 with respect to the nozzle 61 at the fixed position. The change of the relative position of the nozzle 61 with respect to the stage 210 is also simply referred to as movement of the nozzle 61. The movement mechanism 230 is configured by a three-axis positioner that moves the stage 210 in the three-axis directions including the X, Y, and Z directions by driving forces of three motors. Each motor of the movement mechanism 230 is driven under control of the control unit 300.

Note that, in another embodiment, in place of the configuration of moving the stage 210 by the movement mechanism 230, there may be adopted a configuration in which the movement mechanism 230 moves the nozzle 61 with respect to the stage 210 while the position of the stage 210 is fixed. Further, there may be adopted a configuration in which the movement mechanism 230 moves the stage 210 in the Z direction and moves the nozzle 61 in the X and Y directions or a configuration in which the movement mechanism 230 moves the stage 210 in the X and Y directions and moves the nozzle 61 in the Z direction.

The temperature measurement unit 250 measures a temperature distribution of a layer stacked in the modeling surface 211 of the stage 210. For example, the temperature measurement unit 250 is a thermo-camera, a thermo-pile, or the like. The temperature measurement unit 250 is fixed to a barrel case 59 that accommodates the barrel 50. Note that the temperature measurement unit 250 is only required to be provided at a position where the temperature distribution of the layer stacked in the modeling surface 211 can be measured, and may not be fixed to the barrel case 59.

The control unit 300 is a control device that controls an operation of the three-dimensional modeling device 100 as a whole. The control unit 300 is configured by a computer including one or a plurality of processors 310, a storage device 320 formed of a main storage device or an auxiliary storage device, and an input/output interface that inputs and outputs a signal with respect to the outside. The processor 310 executes a program stored in the storage device 320. With this, the processor 310 controls the modeling unit 110 and the movement mechanism 230 according to modeling data acquired from the information processing device 400, and models the three-dimensional modeling object on the stage 210. Note that, in place of a computer, the control unit 300 may be achieved by a configuration obtained by combining circuits.

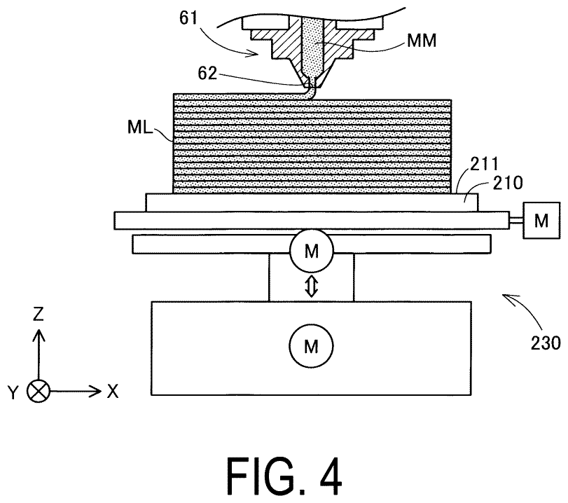

FIG. 4 is an explanatory diagram schematically illustrating a state in which the three-dimensional modeling device 100 models the three-dimensional modeling object. As described above, in the three-dimensional modeling device 100, the raw material MR in a solid state is plasticized to generate a modeling material MM. The control unit 300 causes the nozzle 61 to eject the modeling material MM while maintaining a distance between the modeling surface 211 of the stage 210 and the nozzle 61 and changing the position of the nozzle 61 with respect to the stage 210 in a direction along the modeling surface 211 of the stage 210. The modeling material MM ejected from the nozzle 61 is accumulated continuously in the moving direction of the nozzle 61.

The control unit 300 repeats movement of the nozzle 61 to form a layer ML. The control unit 300 forms one layer ML, and then relatively moves the position of the nozzle 61 with respect to the stage 210 in the Z direction. Further, the three-dimensional modeling object is modeled by further stacking another layer ML on the layer ML thus formed.

For example, when the nozzle 61 moves in the Z direction after one layer ML is completed, or there are a plurality of modeling regions that are independent in each layer, the control unit 300 may temporarily stop ejection of the modeling material from the nozzle 61. In this case, the ejection adjustment unit 70 closes the flow path 65 to stop ejection of the modeling material MM from the nozzle opening 62, and the suction unit 75 temporarily sucks the modeling material remaining in the nozzle 61. The control unit 300 changes the position of the nozzle 61, and then causes the ejection adjustment unit 70 to open the flow path 65 while discharging the modeling material in the suction unit 75. With this, accumulation of the modeling material MM can be re-started from the position of the nozzle 61 after the change.

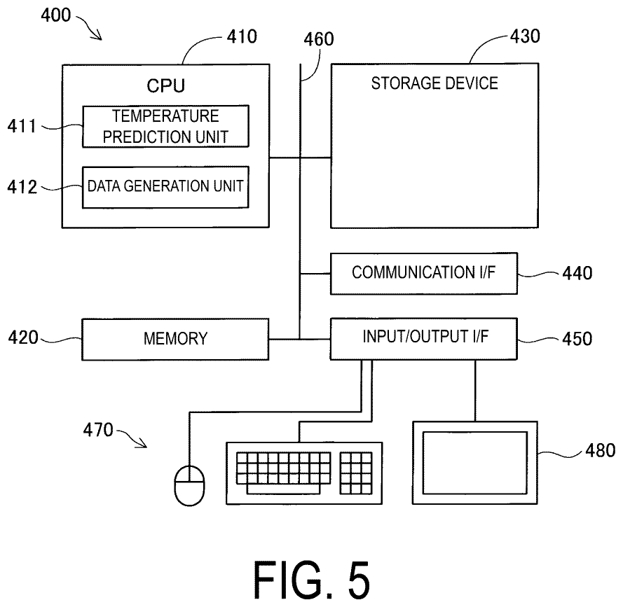

FIG. 5 is an explanatory diagram illustrating a schematic configuration of the information processing device 400. The information processing device 400 is configured as a computer where a CPU 410, a memory 420, a storage device 430, a communication interface 440, and an input/output interface 450 are coupled to each other via the bus 460. An input device 470 such as a keyboard and a mouse and a display device 480 such as a liquid crystal display are coupled to the input/output interface 450. The information processing device 400 is coupled to the control unit 300 of the three-dimensional modeling device 100 via the communication interface 440.

The CPU 410 functions as a temperature prediction unit 411 and a data generation unit 412 by executing programs stored in the storage device 430. The temperature prediction unit 411 predicts the temperature distribution of the layer stacked in the modeling surface 211 of the stage 210. The data generation unit 412 generates the modeling data being data for modeling the three-dimensional modeling object for each layer.

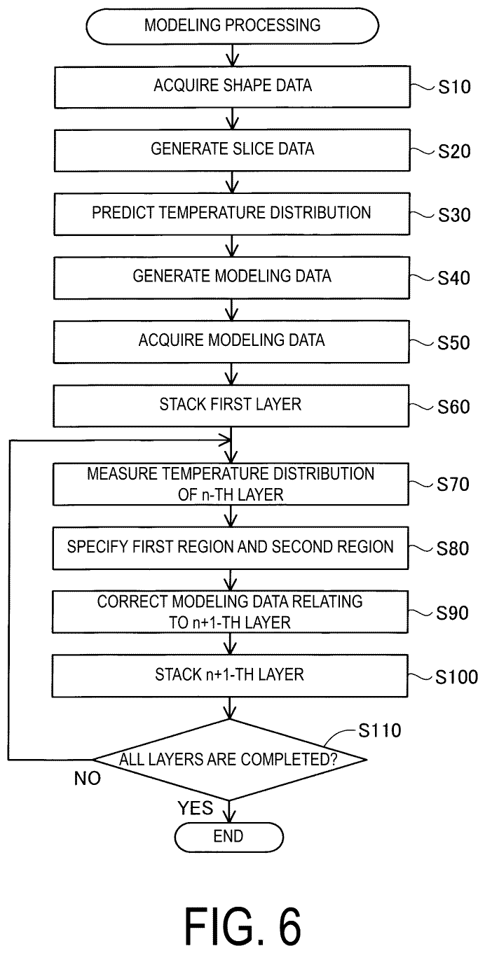

FIG. 6 is a flowchart of modeling processing executed by the information processing device 400 and the three-dimensional modeling device 100. The method of manufacturing a three-dimensional modeling object is achieved by executing the modeling processing. The processing from step S10 to step S40 is executed by the information processing device 400, and the processing from step S50 to step S110 is executed by the three-dimensional modeling device 100.

In step S10, the data generation unit 412 of the information processing device 400 acquires shape data indicating a three-dimensional shape of the three-dimensional modeling object from another computer, a recording medium, or the storage device 430. The shape data is data that is generated by using three-dimensional CAD software, three-dimensional CG software, or the like and indicates the shape of the three-dimensional modeling object. For example, as the shape data, data in an STL format, an AMF format, or other formats may be used.

In step S20, the data generation unit 412 generates slice data. The slice data refers to data indicating the shape of the three-dimensional modeling object sliced into a plurality of layers. More specifically, the data generation unit 412 generates the slice data by slicing the shape of the three-dimensional modeling object, which is indicated by the shape data, into a plurality of layers along the XY plane.

In step S30, the temperature prediction unit 411 predicts the temperature distribution of the layer stacked in the modeling surface 211 of the stage 210. Specifically, the temperature prediction unit 411 predicts the temperature distribution in each layer by simulating a state in which layers are stacked in the modeling surface 211. The temperature prediction unit 411 predicts a temperature distribution of an n-th layer when n layers are stacked, where n is a freely-selected integer equal to or greater than one, in other words, a temperature distribution of the layer stacked on top. In the present specification, the n-th layer is also simply referred to as an n-th layer. Herein, the first layer is the lowermost layer. For example, the temperature prediction unit 411 predicts the temperature distribution of the n-th layer at the time point when a predetermined amount of time elapses after stacking of the n-th layer by simulating a state in which the n-th layer stacked on the n−1-th layer is cooled over time. In the simulation, in each of the layers from the first layer to the n-th layer, an initial temperature at the time point when each layer is stacked is set. The temperature prediction unit 411 predicts the temperature distribution for all the layers forming the three-dimensional modeling object.

The n-th layer includes the first region and a second region. The first region is a region having a temperature lower than the second region. Specifically, the first region is a region having a temperature lower than a reference temperature, and the second region is a region having a temperature higher than the reference temperature. For example, the reference temperature is an average value or a median value of the temperature of the n-th layer. Note that the reference temperature may be a temperature that is set in advance by a user. The temperature prediction unit 411 predicts the positions of the first region and the second region of the n-th layer by predicting the temperature distribution of the n-th layer. Step S30 is also referred to as a temperature prediction step.

In step S40, the data generation unit 412 generates the modeling data, based on the slice data and a modeling condition. Herein, the modeling condition is a line width, a modeling pattern, a filling rate of the three-dimensional modeling object, or the like. The modeling data contains path data, ejection amount information associated with the path data, and a moving speed of the nozzle 61. The path data is data indicating a movement path along which the nozzle 61 moves while ejecting the modeling material, using a plurality of segment paths. The segment path is a line path, and is represented by using a starting point and an ending point of the segment path, for example. The ejection amount information is information indicating an ejection amount of the modeling material in each segment path. The moving speed of the nozzle 61 is a moving speed of the nozzle 61 in a direction along the XY plane when the modeling material is stacked on the stage 210. The moving speed of the nozzle 61 is also referred to as a moving speed of the ejection unit 60. For example, the modeling data is represented by G-code. The data generation unit 412 generates the modeling data for modeling the n+1-th layer, based on the prediction result of the temperature distribution of the n-th layer in step S30. Hereinafter, the modeling data for molding the n-th layer is also simply referred to as the modeling data relating to the n-th layer.

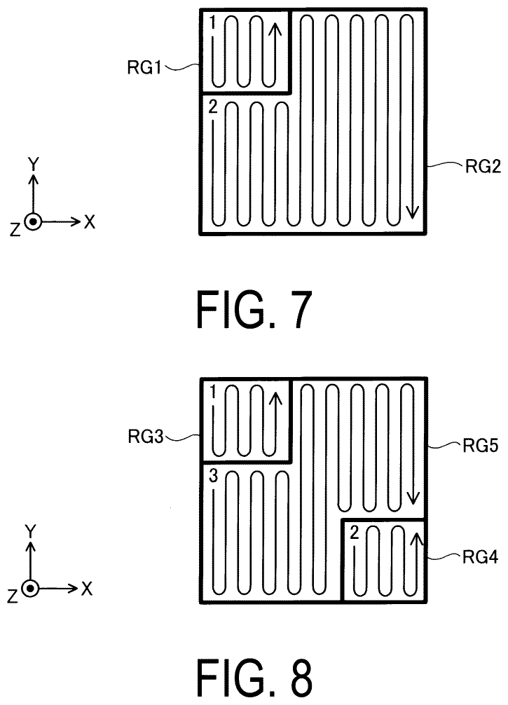

FIG. 7 is a diagram illustrating an example of the movement path of the nozzle 61 contained in the modeling data that is generated in step S40 and relates to the n+1-th layer. FIG. 7 illustrates the positions of the first region RG1 and the second region RG2 of the n-th layer that are predicted in step S30. Further, in FIG. 7, the movement path of the nozzle 61 for stacking the n+1-th layer is indicated with the arrow. The numbers indicated at the starting points of the respective movement paths indicate the order in which the nozzle 61 ejects the modeling material to stack the n+1-th layer. As illustrated in FIG. 7, the data generation unit 412 generates the path data relating to the n+1-th layer so that the modeling material is stacked in the first region RG1 of the n-th layer before being stacked in the second region RG2 of the n-th layer. Further, the data generation unit 412 sets the moving speed of the nozzle 61 for stacking the n+1-th layer. Specifically, the data generation unit 412 sets a first speed and a second speed, the first speed being a moving speed of the nozzle 61 while the modeling material is stacked in the first region RG1 of the n-th layer, the second speed being a moving speed of the nozzle 61 while the modeling material is stacked in the second region RG2 of the n-th layer. The data generation unit 412 sets the first speed to a speed higher than the second speed. In step S40, the data generation unit 412 generates the modeling data relating to all the layers forming the three-dimensional modeling object. Step S40 is also referred to as a first data generation step.

FIG. 8 is a diagram illustrating another example of the movement path of the nozzle 61 contained in the modeling data that is generated in step S40 and relates to the n+1-th layer. In the example illustrated in FIG. 8, the n-th layer includes a plurality of first regions. As illustrated in FIG. 8, when the n-th layer includes two first regions RG3 and RG4 and a second region RG5, the data generation unit 412 generates the modeling data relating to the n+1-th layer so that the modeling material is stacked in the second region RG5 after the modeling material is stacked in the first region RG3 and the first region RG4. Note that, when the n-th layer includes three or more first regions, the data generation unit 412 generates the modeling data relating to the n+1-th layer so that the modeling material is stacked in the second region after the modeling material is stacked in all the first regions.

In step S50 in FIG. 6, the control unit 300 of the three-dimensional modeling device 100 acquires the modeling data generated in step S40 from the information processing device 400.

In step S60, the control unit 300 stacks the first layer according to the modeling data relating to the first layer, which is contained in the modeling data acquired in step S50.

After step S60 is executed, the control unit 300 stacks the second layer to the uppermost layer of the three-dimensional modeling object by repeating the steps from step S70 to step S100 as one cycle. The control unit 300 stacks one layer in one cycle. Hereinafter, a cycle of measuring the temperature distribution of the n-th layer of the three-dimensional modeling object and stacking the n+1-th layer of the three-dimensional modeling object is also referred to as an n-th cycle. In other words, in the n-th cycle, the temperature of the n-th layer is measured, and the n+1-th layer is stacked. When step S70 is executed for the first time, a first cycle is started. In the first cycle, the temperature distribution of the first layer is measured, and the second layer is stacked.

In step S70, the temperature measurement unit 250 measures the temperature distribution of the n-th layer. The temperature measurement unit 250 measures a temperature distribution of a layer that is stacked on top when step S70 is executed. For example, in step S70 in the first cycle, the temperature of the first layer is measured. In step S70 in the second cycle, the temperature of the second layer is measured. The data measured by the temperature measurement unit 250 is transmitted to the control unit 300. Step S70 is also referred to as a temperature measurement step.

In step S80, the control unit 300 acquires the data transmitted from the temperature measurement unit 250. The control unit 300 specifies the actual positions of the first region and the second region of the n-th layer by using the data that is measured by the temperature measurement unit 250 and relates to the temperature distribution of the n-th layer. The data that is measured by the temperature measurement unit 250 and relates to the temperature distribution of the n-th layer is stored in the storage device 320 of the control unit 300. The data that is measured by the temperature measurement unit 250 and relates to the temperature distribution in each layer may be used to improve accuracy of the simulation for predicting the temperature distribution in each layer.

In step S90, the control unit 300 corrects the modeling data relating to the n+1-th layer, based on the measurement result of the temperature distribution of the n-th layer. Specifically, when the positions of the first region and the second region of the n-th layer, which are specified in step S80, are different from the positions of the first region and the second region of the n-th layer, which are predicted in step S30, the control unit 300 corrects the modeling data that is generated in step S40 and relates to the n+1-th layer. The control unit 300 corrects the path data relating to the n+1-th layer so that the modeling material is stacked in the first region of the n-th layer, which is specified in step S80, before being stacked in the second region of the n-th layer, which is specified in step S80. Note that, when the positions of the first region and the second region of the n-th layer, which are specified in step S80, are the same as the positions of the first region and the second region of the n-th layer, which are predicted in step S30, step S90 is not executed. Step S90 is also referred to as a second data generation step. Further, step S40 and step S90 are also collectively referred to as a data generation step.

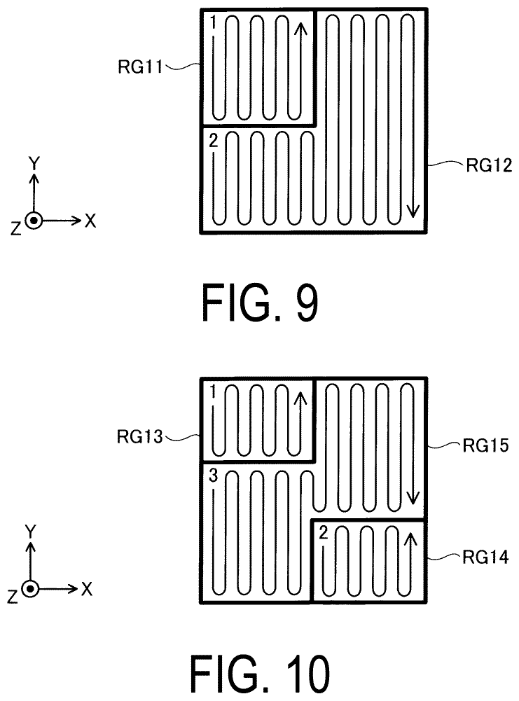

FIG. 9 is a diagram illustrating an example of the movement path of the nozzle 61 contained in the modeling data that is corrected in step S90 and relates to the n+1-th layer. FIG. 9 illustrates positions of a first region RG11 and a second region RG12 of the n-th layer, which are specified in step S80. Further, in FIG. 9, the movement path of the nozzle 61 for stacking the n+1-th layer, which is corrected in step S90, is indicated with the arrow. The numbers indicated at the starting points of the respective movement paths indicate the order in which the nozzle 61 ejects the modeling material to stack the n+1-th layer.

FIG. 10 is a diagram illustrating another example of the movement path of the nozzle 61 contained in the modeling data that is corrected in step S90 and relates to the n+1-th layer. In the example illustrated in FIG. 10, the n-th layer includes a plurality of first regions. As illustrated in FIG. 10, when the n-th layer includes two first regions RG13 and RG14 and a second region RG15, the control unit 300 corrects the modeling data relating to the n+1-th layer so that the modeling material is stacked in the second region RG15 after the modeling material is stacked in the first region RG13 and the first region RG14. Note that, when the n-th layer includes three or more first regions, the control unit 300 corrects the modeling data relating to the n+1-th layer so that the modeling material is stacked in the second region after the modeling material is stacked in all the first regions.

In step S100 in FIG. 6, the control unit 300 models the n+1-th layer according to the modeling data that is corrected in step S90 and relates to the n+1-th layer.

In step S110, the control unit 300 determines whether stacking of all the layers forming the three-dimensional modeling object is completed. When stacking of all the layers is not completed, the control unit 300 returns the processing to step S70, and starts a subsequent cycle. When stacking of all the layers is completed, the control unit 300 terminates the modeling processing.

As described above, in step S100 in the n-th cycle, the n+1-th layer is stacked. In step S100 in the n+1-th cycle, the n+2-th layer is stacked. In other words, in step S100 in the n−1-th cycle, the n-th layer is stacked. In step S100 in the n-th cycle, the n+1-th layer is stacked. In the present specification, step S100 in the n−1-th cycle is also referred to as a first stacking step, and step S100 in the n-th cycle is also referred to as a second stacking step. Note that, when step S70 is executed for the first time, step S60 is referred to as a first stacking step, and step S100 in the first cycle is referred to as a second stacking step.

According to the first embodiment described above, the method of manufacturing a three-dimensional modeling object includes the first stacking step for stacking the n-th layer, at least one step of the temperature prediction step for predicting the temperature distribution of the n-th layer and the temperature measurement step for measuring the temperature distribution of the n-th layer, the data generation step for generating or correcting the modeling data relating to the n+1-th layer, based on the temperature distribution of the n-th layer, and the second stacking step for stacking the n+1-th layer, based on the modeling data relating to the n+1-th layer. In the data generation step, the modeling data relating to the n+1-th layer is generated or corrected so that the modeling material is stacked in the first region of the n-th layer before being stacked in the second region of the n-th layer. Herein, the first region is a region having a temperature lower than the second region. The adhesion strength between the n-th layer and the n+1-th layer depends on the temperature of the n-th layer when the n+1-th layer is stacked. Herein, the adhesion strength is strength in a stacking direction. In the embodiment, the stacking direction is the Z direction. Thus, in the method of manufacturing a three-dimensional modeling object of the first embodiment, as compared to a case of stacking the n+1-th layer without considering the temperature distribution of the n-th layer, a temperature of each part of the n-th layer can be more uniform when the modeling material forming the n+1-th layer is stacked on the n-th layer. Therefore, the adhesion strength between the n-th layer and the n+1-th layer can be uniform regardless of the position on the XY plane. As a result, quality of a three-dimensional modeling object modeled by stacking layers can be improved.

Further, in the embodiment, when the n-th layer includes the plurality of first regions, the modeling data relating to the n+1-th layer is generated or corrected in the data generation step so that the modeling material is stacked in the second region after the modeling material is stacked in the plurality of first regions. Thus, even when the n-th layer includes the plurality of first regions, the adhesion strength between the n-th layer and the n+1-th layer can be uniform regardless of the position on the XY plane.

Further, in the embodiment, in the data generation step, the data generation unit 412 sets the first speed being a moving speed of the nozzle 61 while the modeling material is stacked in the first region of the n-th layer and the second speed being a moving speed of the nozzle 61 while the modeling material is stacked in the second region of the n-th layer. The first speed is a speed higher than the second speed. Thus, the decrease in the temperature of the first region can be suppressed until the modeling material is stacked in the entire first region of the n-th layer. Further, time can be gained for the temperature of the second region to decrease until the modeling material is stacked in the entire second region of the n-th layer.

Further, in the embodiment, the method of manufacturing a three-dimensional modeling object includes the temperature prediction step and the temperature measurement step, and the data generation step includes the first data generation step and the second data generation step. In the first data generation step, the modeling data relating to the n+1-th layer is generated based on the prediction result of the temperature distribution of the n-th layer in the temperature prediction step. In the second data generation step, the modeling data that is generated in the first data generation step and relates to the n+1-th layer is corrected based on the measurement result of the temperature distribution of the n-th layer in the temperature measurement step. Thus, when the temperature distribution of the n-th layer, which is predicted in the temperature prediction step, and the temperature distribution of the n-th layer, which is measured in the temperature measurement step, are different from each other, the modeling data relating to the n+1-th layer is corrected based on the temperature distribution of the n-th layer, which is measured in the temperature measurement step. With this, the adhesion strength between the n-th layer and the n+1-th layer can be uniform regardless of the position on the XY plane. Further, when the measurement result of the temperature distribution in each layer is different from the prediction result, the shape of the three-dimensional modeling object is changed, or the modeling data is corrected so as to simultaneously model a temperature protection wall around a part where the temperature tends to decrease. With this, quality of the three-dimensional modeling object can be improved more.

### B. Second Embodiment

A second embodiment is different from the first embodiment in the contents of the modeling data generated or corrected in the modeling processing. The configuration of each of the units of the three-dimensional modeling system 10 of the second embodiment is similar to that of the first embodiment.

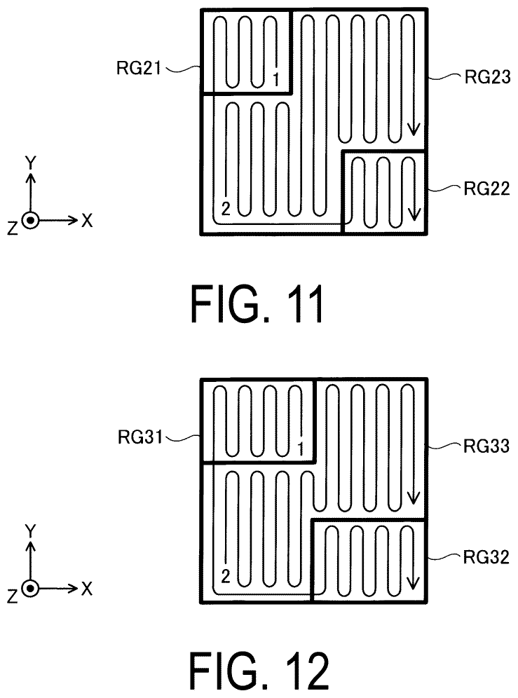

FIG. 11 is a diagram illustrating an example of the movement path of the nozzle 61 contained in the modeling data that is generated in step S40 in the modeling processing and relates to the n+1-th layer in the second embodiment. In the example illustrated in FIG. 11, the n-th layer includes the plurality of first regions and the second region contacting with the plurality of first regions. As illustrated in FIG. 11, when the n-th layer includes two first regions RG21 and RG22 and a second region RG23 contacting with the first region RG21 and the first region RG22, the data generation unit 412 generates the modeling data relating to the n+1-th layer so that the modeling material is stacked in the first region RG21 and the first region RG22 without stopping ejection of the modeling material while allowing stacking of the modeling material on the second region RG23. Specifically, the data generation unit 412 generates the path data relating to the n+1-th layer so as to stack the modeling material in the following manner. First, the modeling material is stacked in one first region RG21, and then the modeling material is stacked in a part of the second region RG23. At the same time, the nozzle 61 moves above the other first region RG22, and the modeling material is stacked in the first region RG22. Further, the modeling material is stacked in the remaining part of the second region RG23. Note that, when the n-th layer includes three or more first regions, the data generation unit 412 generates the modeling data relating to the n+1-th layer so that the modeling material is stacked in all the first regions without stopping ejection of the modeling material while allowing stacking of the modeling material on the second region.

FIG. 12 is a diagram illustrating an example of the movement path of the nozzle 61 contained in the modeling data that is corrected in step S90 in the modeling processing and relates to the n+1-th layer in the second embodiment. In the example illustrated in FIG. 12, the n-th layer includes the plurality of first regions and the second region contacting with the plurality of first regions. As illustrated in FIG. 12, when the n-th layer includes two first regions RG31 and RG32 and a second region RG33 contacting with the first region RG31 and the first region RG32, the control unit 300 corrects the modeling data relating to the n+1-th layer so that the modeling material is stacked in the first region RG31 and the first region RG32 without stopping ejection of while allowing stacking of the modeling material on the second region RG33. Specifically, the control unit 300 corrects the path data relating to the n+1-th layer so as to stack the modeling material in the following manner. First, the modeling material is stacked in one first region RG31, and then the modeling material is stacked on a part of the second region RG33. At the same time, the nozzle 61 moves above the other first region RG32, and the modeling material is stacked in the first region RG32. Further, the modeling material is stacked in the remaining part of the second region RG33. Note that, when the n-th layer includes three or more first regions, the control unit 300 corrects the modeling data relating to the n+1-th layer so that the modeling material is stacked in all the first regions without stopping ejection of the modeling material while allowing stacking of the modeling material on the second region.

According to the second embodiment described above, when the n+1-th layer is stacked, the number of times ejection of the modeling material from the nozzle 61 is temporarily stopped can be reduced.

### C. Third Embodiment

A third embodiment is different from the first embodiment in the contents of the modeling processing. The configuration of each of the units of the three-dimensional modeling system 10 of the third embodiment is similar to that of the first embodiment.

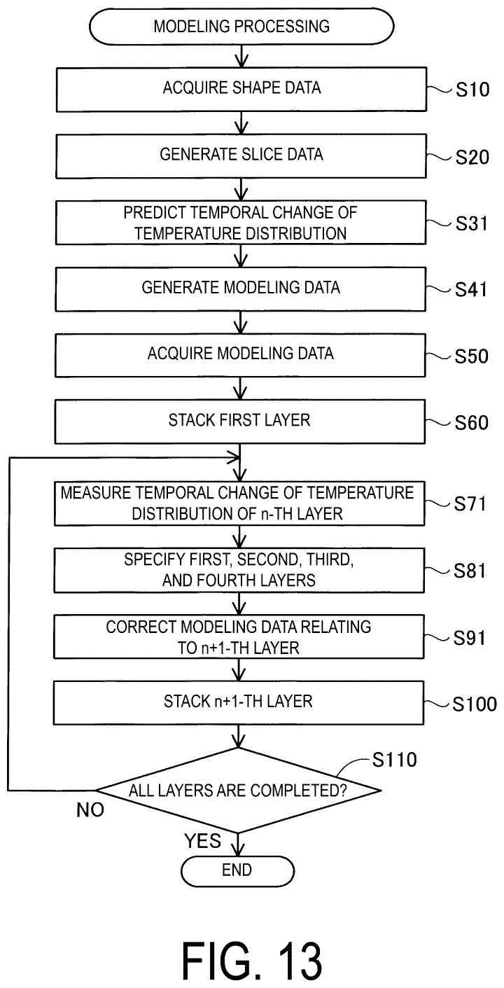

FIG. 13 is a flowchart of the modeling processing in the third embodiment. Note that a section where processing is similar to the modeling processing in the first embodiment is denoted with the same reference symbol, and description therefor is omitted.

In step S31, the temperature prediction unit 411 predicts the temporal change of the temperature distribution of the layer stacked on the modeling surface 211 of the stage 210. Specifically, the temperature prediction unit 411 predicts the temporal change of the temperature distribution in each layer by simulating a state in which layers are stacked on the modeling surface 211. The temporal change of the temperature distribution of the layer refers to the temperature drop rate of the layer per unit time after stacking of the layer is completed. Specifically, the temporal change of the temperature distribution of the layer refers to the temperature drop rate of the layer per unit time when a predetermined amount of time elapses after completion of stacking of the layer. The temperature prediction unit 411 predicts the temporal change of the temperature distribution of the n-th layer when the n layers are stacked, in other words, the temperature distribution of the layer stacked on top. For example, for each part of the n-th layer, the temperature prediction unit 411 predicts the temperature drop rate per unit time when a predetermined amount of time elapses after stacking of the n-th layer by simulating a state in which the n-th layer stacked on the n−1-th layer is cooled over time. In the simulation, in each of the layers from the first layer to the n-th layer, the initial temperature at the time point when each layer is stacked is set. The temperature prediction unit 411 predicts the temporal change of the temperature distribution for all the layers forming the three-dimensional modeling object.

The first region or the second region of the n-th layer includes a third region and a fourth region. The third region is a region having a temperature reduced more rapidly than the fourth region. In other words, the third region is a region where the temperature drop rate per unit time is higher than that of the fourth region. The temperature prediction unit 411 predicts the positions of the first region, the second region, the third region, and the fourth region of the n-th layer by predicting the temporal change of the temperature distribution of the n-th layer.

In step S41, the data generation unit 412 generates the modeling data for modeling the n+1-th layer, based on the temporal change of the temperature distribution of the n-th layer, which is predicted in step S31.

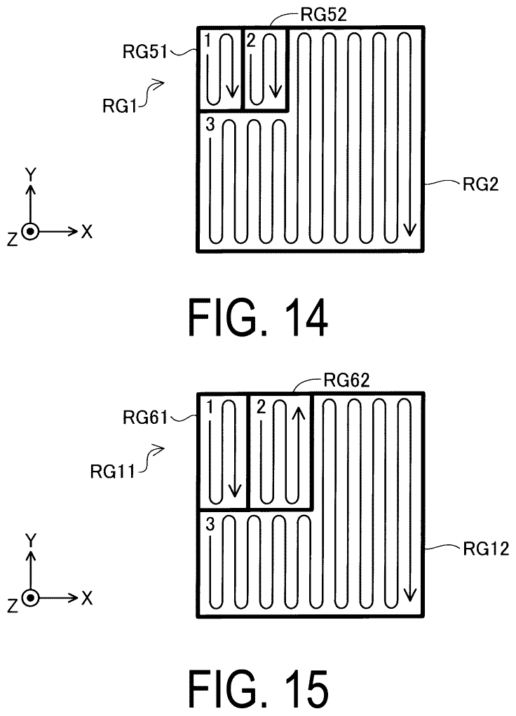

FIG. 14 is a diagram illustrating an example of the movement path of the nozzle 61 contained in the modeling data that is generated in step S41 and relates to the n+1-th layer. FIG. 14 illustrates positions of the first region RG1 of the n-th layer, the second region RG2, a third region RG51, and a fourth region RG52, which are predicted in step S31. In the example illustrated in FIG. 14, the first region RG1 includes the third region RG51 and the fourth region RG52. Further, in FIG. 14, the movement path of the nozzle 61 for stacking the n+1-th layer is indicated with the arrow. As illustrated in FIG. 14, the data generation unit 412 generates the path data relating to the n+1-th layer so that the modeling material is stacked in the first region RG1 of the n-th layer before being stacked in the second region RG2 of the n-th layer and the modeling material is stacked in the third region RG51 before being stacked in the fourth region RG52. In other words, the data generation unit 412 generates the path data relating to the n+1-th layer so that the modeling material is stacked sequentially on the third region RG51 of the first region RG1, the fourth region RG52 of the first region RG1, and the second region RG2. Note that, when the second region RG2 includes the third region RG51 and the fourth region RG52, the data generation unit 412 generates the modeling data relating to the n+1-th layer so that the modeling material is stacked sequentially on the first region RG1, the third region RG51 of the second region RG2, and the fourth region RG52 of the second region RG2.

In step S71 in FIG. 13, the temperature measurement unit 250 measures the temporal change of the temperature distribution of the n-th layer. In other words, the temperature measurement unit 250 measures the temporal change of the temperature distribution of the layer stacked on top when step S71 is executed. The data measured by the temperature measurement unit 250 is transmitted to the control unit 300.

In step S81, the control unit 300 acquires the data transmitted from the temperature measurement unit 250. The control unit 300 specifies the actual positions of the first region, the second region, the third region, and the fourth region of the n-th layer by using the data that is measured by the temperature measurement unit 250 and relates to the temporal change of the temperature distribution of the n-th layer. The data that is measured by the temperature measurement unit 250 and relates to the temporal change of the temperature distribution of the n-th layer is stored in the storage device 320 of the control device.

In step S91, the control unit 300 corrects the modeling data relating to the n+1-th layer, based on the measurement result of the temporal change of the temperature distribution of the n-th layer. Specifically, when the positions of the first region, the second region, the third region, and the fourth region of the n-th layer, which are specified in step S81, are different from the positions of the first region, the second region, the third region, and the fourth region of the n-th layer, which are predicted in step S31, the control unit 300 corrects the modeling data that is generated in step S41 and relates to the n+1-th layer. The control unit 300 corrects the path data relating to the n+1-th layer so that the modeling material is stacked in the first region of the n-th layer, which is specified in step S81, before being stacked in the second region of the n-th layer, which is specified in step S81. Further, the control unit 300 corrects the path data relating to the n+1-th layer so that the modeling material is stacked in the third region of the n-th layer, which is specified in step S81, before being stacked in the fourth region of the n-th layer, which is specified in step S81. Note that, when the positions of the first region, the second region, the third region, and the fourth region of the n-th layer, which are specified in step S81, are the same as the positions of the first region, the second region, the third region, and the fourth region of the n-th layer, which are predicted in step S31, step S91 is not executed.

FIG. 15 is a diagram illustrating an example of the movement path of the nozzle 61 contained in the modeling data that is corrected in step S91 and relates to the n+1-th layer. FIG. 15 illustrates positions of the first region RG11, the second region RG12, a third region RG61, and a fourth region RG62 of the n-th layer, which are specified in step S81. In the example illustrated in FIG. 15, the first region RG1 includes the third region RG61 and the fourth region RG62. Further, in FIG. 15, the movement path of the nozzle 61 for stacking the n+1-th layer, which is corrected in step S91, is indicated with the arrow. As illustrated in FIG. 15, the control unit 300 corrects the path data relating to the n+1-th layer so that the modeling material is stacked sequentially on the third region RG61 of the first region RG11, the fourth region RG62 of the first region RG11, and the second region RG12. Note that, when the second region RG12 includes the third region RG61 and the fourth region RG62, the control unit 300 corrects the modeling data relating to the n+1-th layer so that the modeling material is stacked sequentially on the first region RG11, the third region RG61 of the second region RG12, and the fourth region RG62 of the second region RG12.

According to the third embodiment described above, the method of manufacturing a three-dimensional modeling object includes the data generation step for generating or correcting the modeling data relating to the n+1-th layer, based on the temporal change of the temperature distribution of the n-th layer, so that the modeling material is stacked in the third region before being stacked in the fourth region. Herein, the third region is a region having a temperature reduced more rapidly than the fourth region. Thus, a temperature of each part of the n-th layer can be more uniform when the modeling material forming the n+1-th layer is stacked on the n-th layer. Therefore, the adhesion strength between the n-th layer and the n+1-th layer can be uniform regardless of the position on the XY plane.

### D. Fourth Embodiment

A fourth embodiment is different from the first embodiment in the contents of the modeling processing. The configuration of each of the units of the three-dimensional modeling system 10 of the fourth embodiment is similar to that of the first embodiment.

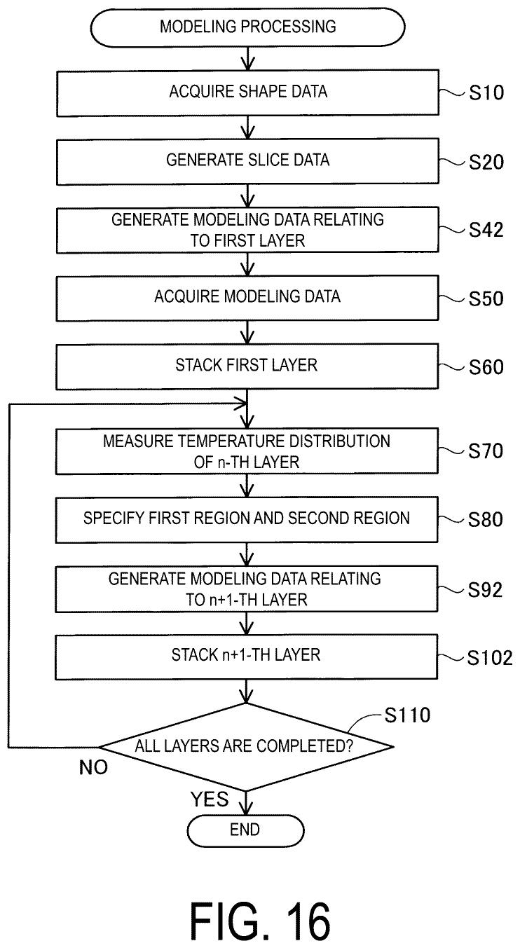

FIG. 16 is a flowchart of the modeling processing in the fourth embodiment. Note that a section where processing is similar to the modeling processing in the first embodiment is denoted with the same reference symbol, and description therefor is omitted.

In the fourth embodiment, step S30 is not executed. In other words, the temperature prediction unit 411 does not predict the temperature distribution of the layer stacked on the modeling surface 211 of the stage 210.

In step S42, the data generation unit 412 generates the modeling data relating to the first layer.

In step S92, the control unit 300 generates the modeling data relating to the n+1-th layer, based on the measurement result of the temperature distribution of the n-th layer. Specifically, the control unit 300 generates the path data relating to the n+1-th layer so that the modeling material is stacked in the first region of the n-th layer, which is specified in step S80, before being stacked in the second region of the n-th layer, which is specified in step S80.

In step S102, the control unit 300 models the n+1-th layer according to the modeling data that is generated in step S92 and relates to the n+1-th layer.

According to the fourth embodiment described above, the modeling data relating to the n+1-th layer is generated based on the measurement result of the temperature distribution of the n-th layer. Thus, as compared to a case of stacking the n+1-th layer without considering the temperature distribution of the n-th layer, a temperature of each part of the n-th layer can be more uniform when the modeling material forming the n+1-th layer is stacked on the n-th layer. Therefore, the adhesion strength between the n-th layer and the n+1-th layer can be uniform regardless of the position on the XY plane.

### E. Fifth Embodiment

A fifth embodiment is different from the third embodiment in the contents of the modeling processing. The configuration of each of the units of the three-dimensional modeling system 10 of the fifth embodiment is similar to that of the third embodiment.

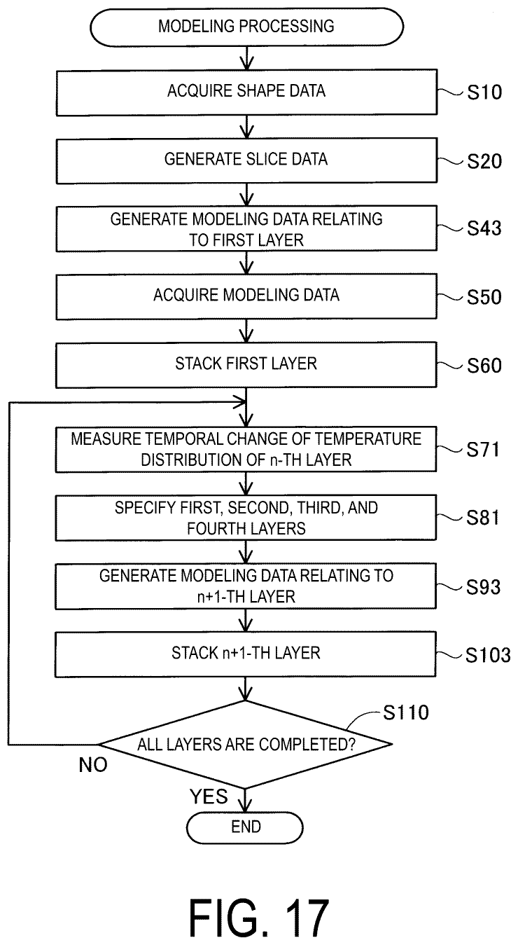

FIG. 17 is a flowchart of the modeling processing in the fifth embodiment. Note that a section where processing is similar to the modeling processing in the first embodiment and the third embodiment is denoted with the same reference symbol, and description therefor is omitted.

In the fifth embodiment, step S31 is not executed. In other words, the temperature prediction unit 411 does not predict the temporal change of the temperature distribution of the layer stacked on the modeling surface 211 of the stage 210.

In step S43, the data generation unit 412 generates the modeling data relating to the first layer.

In step S93, the control unit 300 generates the modeling data relating to the n+1-th layer, based on the measurement result of the temporal change of the temperature distribution of the n-th layer. Specifically, the control unit 300 generates the path data relating to the n+1-th layer so that the modeling material is stacked in the first region of the n-th layer, which is specified in step S81, before being stacked in the second region of the n-th layer, which is specified in step S81. Further, the control unit 300 generates the path data relating to the n+1-th layer so that the modeling material is stacked in the third region of the n-th layer, which is specified in step S81, before being stacked in the fourth region of the n-th layer, which is specified in step S81.

In step S103, the control unit 300 models the n+1-th layer according to the modeling data that is generated in step S93 and relates to the n+1-th layer.

According to the fifth embodiment described above, the modeling data relating to the n+1-th layer is generated based on the measurement result of the temporal change of the temperature distribution of the n-th layer. Thus, a temperature of each part of the n-th layer can be more uniform when the modeling material forming the n+1-th layer is stacked on the n-th layer. Therefore, the adhesion strength between the n-th layer and the n+1-th layer can be uniform regardless of the position on the XY plane.

### F. Sixth Embodiment

A sixth embodiment is different from the fifth embodiment in the contents of the modeling processing. The configuration of each of the units of the three-dimensional modeling system 10 of the sixth embodiment is similar to that of the fifth embodiment.

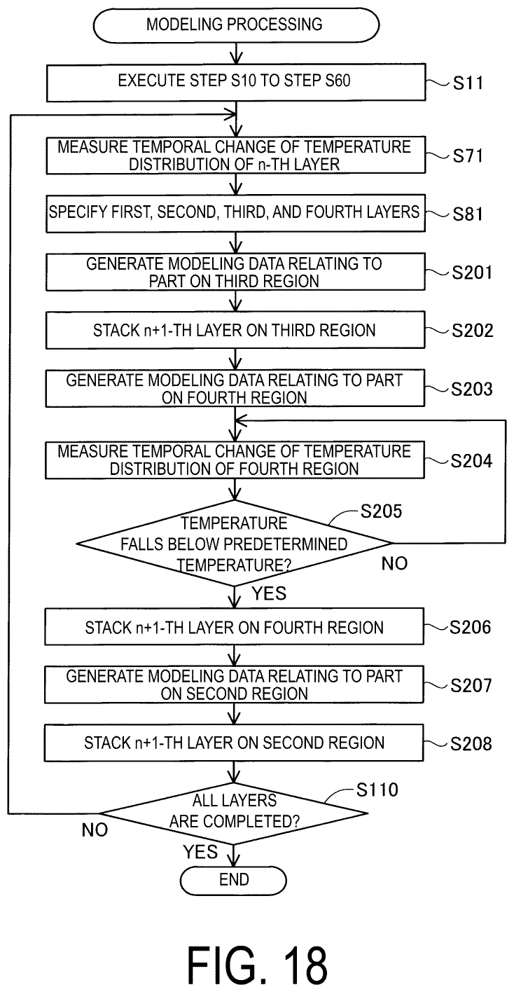

FIG. 18 is a flowchart of the modeling processing in the sixth embodiment. Note that a section where processing is similar to the modeling processing in the first embodiment, the third embodiment, and the fifth embodiment is denoted with the same reference symbol, and description therefor is omitted. A case in which the first region includes the third region and the fourth region is described below.

In step S11, the steps from step S10 to step S60 of the fifth embodiment, which are illustrated in FIG. 17, are executed. Specifically, in step S11, the processing in step S10, step S20, step S43, step S50, and step S60 illustrated in FIG. 17 is executed sequentially in the stated order. After step S11 is executed, step S71 and step S81 illustrated in FIG. 17 are sequentially executed.

In step S201, the control unit 300 generates the modeling data relating to the n+1-th layer, which corresponds to the part positioned on the third region of the n-th layer.

In step S202, the control unit 300 performs stacking of the part of the n+1-th layer, which is positioned on the third region of the n-th layer, according to the modeling data generated in step S201.

In step S203, the control unit 300 generates the modeling data relating to the n+1-th layer, which corresponds to the part positioned on the fourth region of the n-th layer.

In step S204, the temperature measurement unit 250 measures the temporal change of the temperature distribution of the fourth region of the n-th layer.

In step S205, the control unit 300 determines whether the temperature of the fourth region of the n-th layer falls below a predetermined temperature. The predetermined temperature may be a temperature that is equal to or lower than th upper limit value of the temperature at which the shape of the n-th layer can be maintained when the n+1-th layer is stacked and a temperature that is equal to or higher than a temperature at which inter-layer adhesion between the n-th layer and the n+1-th layer is maximized. When the temperature of the fourth region of the n-th layer falls below the predetermined temperature, step S206 is executed. When the temperature of the fourth region of the n-th layer does not fall below the predetermined temperature, the control unit 300 returns the processing to step S204.

In step S206, the control unit 300 performs stacking of the part of the n+1-th layer, which is positioned on the fourth region of the n-th layer, according to the modeling data generated in step S203.

In step S207, the control unit 300 generates the modeling data relating to the n+1-th layer, which corresponds to the part positioned on the second region of the n-th layer.

In step S208, the control unit 300 performs stacking of the part of the n+1-th layer, which is positioned on the second region of the n-th layer, according to the modeling data generated in step S207.

According to the sixth embodiment described above, when the temperature of the fourth region of the n-th layer falls below the predetermined temperature, stacking of the part of the n+1-th layer, which is positioned on the fourth region of the n-th layer, is performed. Thus, the shape of the three-dimensional modeling object can be prevented from collapsing when the n+1-th layer is stacked in the fourth region of the n-th layer. Further, inter-layer adhesion between the n-th layer and the n+1-th layer can be improved.

### G. Seventh Embodiment

A seventh embodiment is different from the first embodiment in the contents of the modeling processing. The configuration of each of the units of the three-dimensional modeling system 10 of the seventh embodiment is similar to that of the first embodiment.

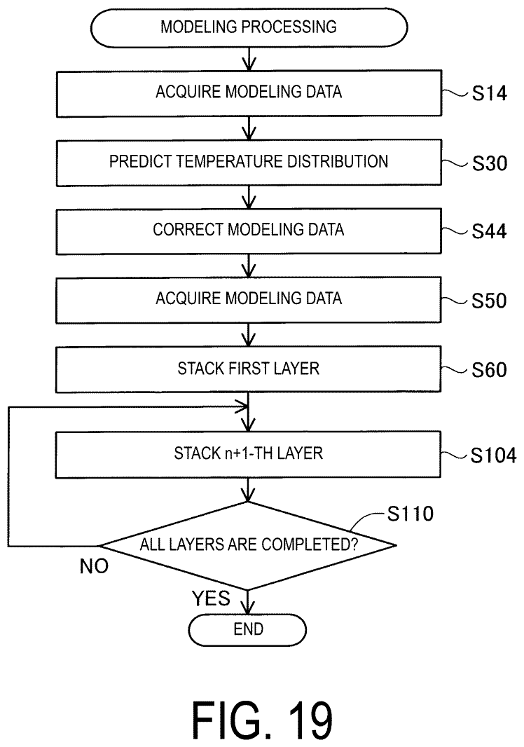

FIG. 19 is a flowchart of the modeling processing in the seventh embodiment. Note that a section where processing is similar to the modeling processing in the first embodiment is denoted with the same reference symbol, and description therefor is omitted.

In step S14, the data generation unit 412 acquires the modeling data from another computer, a recording medium, or the storage device 430. The modeling data acquired by the data generation unit 412 in step S14 is the modeling data relating to all the layers forming the three-dimensional modeling object.

In step S30, the temperature prediction unit 411 predicts the temperature distribution of the layer stacked on the modeling surface 211 of the stage 210.

In step S44, the data generation unit 412 corrects the modeling data relating to the n+1-th layer, based on the prediction result of the temperature distribution of the n-th layer in step S30. Specifically, the data generation unit 412 corrects the path data relating to the n+1-th layer so that the modeling material is stacked in the first region of the n-th layer, which is predicted in step S30, before being stacked in the second region of the n-th layer, which is predicted in step S30. The data generation unit 412 corrects the path data relating to all the layers forming the three-dimensional modeling object. After step S44 is executed, step S50 and step S60 are sequentially executed. In the seventh embodiment, step S70, step S80, and step S90 are not executed. In other words, the temperature measurement unit 250 does not measure the temperature distribution of the n-th layer. Further, the control unit 300 does not correct the modeling data relating to the n+1-th layer, based on the measurement result of the temperature distribution of the n-th layer.

In step S104, the control unit 300 models the n+1-th layer according to the modeling data corrected in step S44.

According to the seventh embodiment described above, the modeling data relating to the n+1-th layer is corrected based on the prediction result of the temperature distribution of the n-th layer. Thus, as compared to a case of stacking the n+1-th layer without considering the temperature distribution of the n-th layer, a temperature of each part of the n-th layer can be more uniform when the modeling material forming the n+1-th layer is stacked on the n-th layer. Therefore, the adhesion strength between the n-th layer and the n+1-th layer can be uniform regardless of the position on the XY plane.

### H. Eighth Embodiment

An eighth embodiment is different from the third embodiment in the contents of the modeling processing. The configuration of each of the units of the three-dimensional modeling system 10 of the eighth embodiment is similar to that of the third embodiment.

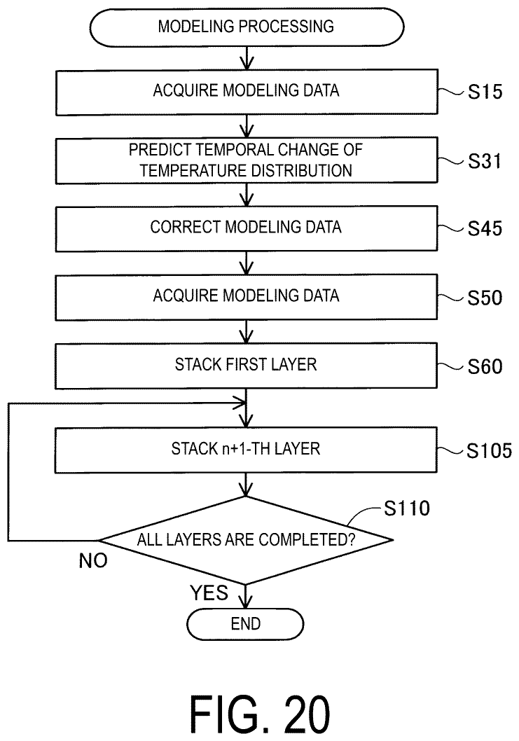

FIG. 20 is a flowchart of the modeling processing in the eighth embodiment. Note that a section where processing is similar to the modeling processing in the first embodiment and the third embodiment is denoted with the same reference symbol, and description therefor is omitted.

In step S15, the data generation unit 412 acquires the modeling data from another computer, a recording medium, or the storage device 430.

In step S31, the temperature prediction unit 411 predicts the temporal change of the temperature distribution of the layer stacked on the modeling surface 211 of the stage 210.

In step S45, the data generation unit 412 corrects the modeling data relating to the n+1-th layer, based on the prediction result of the temporal change of the temperature distribution of the n-th layer in step S31. Specifically, the data generation unit 412 corrects the path data relating to the n+1-th layer so that the modeling material is stacked in the first region of the n-th layer, which is predicted in step S31, before being stacked in the second region of the n-th layer, which is predicted in step S31 and the modeling material is stacked in the third region of the n-th layer, which is predicted in step S31, before being stacked in the fourth region of the n-th layer, which is predicted in step S31. The data generation unit 412 corrects the path data relating to all the layers forming the three-dimensional modeling object. After step S45 is executed, step S50 and step S60 are sequentially executed. In the eighth embodiment, step S71, step S81, and step S91 are not executed. In other words, the temperature measurement unit 250 does not measure the temporal change of the temperature distribution of the n-th layer. Further, the control unit 300 does not correct the modeling data relating to the n+1-th layer, based on the measurement result of the temporal change of the temperature distribution of the n-th layer.

In step S105, the control unit 300 models the n+1-th layer according to the modeling data corrected in step S45.

According to the eighth embodiment described above, the modeling data relating to the n+1-th layer is corrected based on the prediction result of the temporal change of the temperature distribution of the n-th layer. Thus, a temperature of each part of the n-th layer can be more uniform when the modeling material forming the n+1-th layer is stacked on the n-th layer. Therefore, the adhesion strength between the n-th layer and the n+1-th layer can be uniform regardless of the position on the XY plane.

### I. Other Embodiments

(I-1) In the first embodiment and the second embodiment, in step S30 in the modeling processing, the temperature prediction unit 411 predicts the temperature distribution of the layer stacked on the modeling surface 211 of the stage 210. Further, in step S40, the data generation unit 412 generates the modeling data for modeling the n+1-th layer, based on the prediction result of the temperature distribution of the n-th layer in step S30. In contrast, step S30 may not be executed. In this case, in step S40, the data generation unit 412 generates the modeling data, based on the slice data and the modeling condition.

(I-2) In the third embodiment, in step S31 in the modeling processing, the temperature prediction unit 411 predicts the temporal change of the temperature distribution of the layer stacked on the modeling surface 211 of the stage 210. Further, in step S41, the data generation unit 412 generates the modeling data for modeling the n+1-th layer, based on the temporal change of the temperature distribution of the n-th layer, which is predicted in step S31. In contrast, step S31 may not be executed. In this case, step S41, the data generation unit 412 generates the modeling data, based on the slice data and the modeling condition.

(I-3) In the first embodiment and the second embodiment, in step S70 in the modeling processing, the temperature measurement unit 250 measures the temperature distribution of the n-th layer. Further, in step S80, the control unit 300 specifies the actual positions of the first region and the second region of the n-th layer by using the data relating to the temperature distribution of the n-th layer. Further, in step S90, the control unit 300 corrects the modeling data relating to the n+1-th layer, based on the measurement result of the temperature distribution of the n-th layer. In contrast, step S70, step S80, and step S90 in the modeling processing may not be executed. In this case, in step S100, the control unit 300 stacks the n+1-th layer according to the modeling data generated in step S40.

(I-4) In the third embodiment, in step S71 in the modeling processing, the temperature measurement unit 250 measures the temporal change of the temperature distribution of the n-th layer. Further, in step S81, the control unit 300 specifies the actual positions of the first region, the second region, the third region, and the fourth region of the n-th layer by using the data that is measured by the temperature measurement unit 250 and relates to the temporal change of the temperature distribution of the n-th layer. Further, in step S91, the control unit 300 corrects the modeling data relating to the n+1-th layer, based on the measurement result of the temporal change of the temperature distribution of the n-th layer. In contrast, step S71, step S81, and step S91 in the modeling processing may not be executed. In this case, in step S100, the control unit 300 stacks the n+1-th layer according to the modeling data generated in step S41.

(I-5) In the embodiments described above, the data generation unit 412 sets the first speed and the second speed in the first data generation step. In contrast, the control unit 300 may set the first speed and the second speed in the second data generation step.

(I-6) In the embodiments described above, the data generation unit 412 sets the first speed and the second speed in the data generation step. In contrast, in the modeling processing, the first speed and the second speed may not be set.

(I-7) In the embodiments described above, the three-dimensional modeling system 10 includes the information processing device 400. In contrast, the three-dimensional modeling system 10 may not include the information processing device 400. In this case, the steps of the modeling processing executed by the information processing device 400 in the embodiments described above are executed by the control unit 300.

### J. Other Aspects

The present disclosure is not limited to the embodiments described above, and may be achieved in various aspects without departing from the spirits of the disclosure. For example, the present disclosure may be achieved through the following aspects. Appropriate replacements or combinations may be made to the technical features in the above-described embodiments which correspond to the technical features in the aspects described below to solve some or all of the problems of the disclosure or to achieve some or all of the advantageous effects of the disclosure. Further, even when technical characteristics are not described as essential ones in the present specification, it is possible to delete the technical characteristics in the embodiments appropriately.

(1) According to a first aspect of the present disclosure, a method of manufacturing a three-dimensional modeling object is provided. The method of manufacturing a three-dimensional modeling is a method of manufacturing a three-dimensional modeling object, the method being executed to model a three-dimensional modeling object by ejecting a modeling material from an ejection unit of a three-dimensional modeling device and stacking a plurality of layers according to modeling data for modeling the three-dimensional modeling object layer by layer, the modeling data being generated based on shape data indicating a shape of the three-dimensional modeling object, the method including a first stacking step for stacking an n-th layer by ejecting the modeling material from the ejection unit, where n is a freely-selected integer equal to or greater than one, at least one step of a temperature measurement step for measuring a temperature distribution of the n-th layer and a temperature prediction step for predicting a temperature distribution of the n-th layer, a data generation step for generating or correcting the modeling data relating to an n+1-th layer, based on the temperature distribution of the n-th layer, and a second stacking step for stacking the n+1-th layer by ejecting the modeling material from the ejection unit, based on the modeling data that is generated or corrected and relates to the n+1-th layer, wherein the n-th layer includes a first region and a second region, the first region is a region having a temperature lower than the second region, and, in the data generation step, the modeling data relating to the n+1-th layer is generated or corrected so that the modeling material is stacked in the first region before being stacked in the second region.

According to the aspect, as compared to a case of stacking the n+1-th layer without considering the temperature distribution of the n-th layer, a temperature of each part of the n-th layer can be more uniform when the modeling material forming the n+1-th layer is stacked on the n-th layer. Therefore, quality of a three-dimensional modeling object modeled by stacking layers can be improved.

(2) In the aspect described above, the n-th layer may include a plurality of first regions and the second region contacting with the plurality of first regions, and, in the data generation step, the modeling data relating to the n+1-th layer may be generated or corrected so that the modeling material is stacked in the plurality of first regions without stopping ejection of the modeling material while allowing stacking of the modeling material on the second region.

According to the aspect, when the n+1-th layer is stacked, the number of times ejection of the modeling material from the ejection unit is temporarily stopped can be reduced.

(3) In the aspect described above, the n-th layer may include a plurality of first regions, and, in the data generation step, the modeling data relating to the n+1-th layer may be generated or corrected so that the modeling material is stacked in the second region after the modeling material is stacked in the plurality of first regions.

According to the aspect, in a case in which the n-th layer includes the plurality of first regions, when the modeling material forming the n+1-th layer is stacked on the n-th layer, a temperature of each part of the n-th layer can be more uniform.

(4) In the aspect described above, in the temperature measurement step, a temporal change of a temperature distribution of the n-th layer may be measured, in the temperature prediction step, a temporal change of a temperature distribution of the n-th layer may be predicted, the first region or the second region may include a third region and a fourth region, the third region may be a region having a temperature reduced more rapidly than the fourth region, and, in the data generation step, the modeling data relating to the n+1-th layer may be generated or corrected based on the temporal change of the temperature distribution of the n-th layer so that the modeling material is stacked in the third region before being stacked in the fourth region.

According to the aspect, a temperature of each part of the n-th layer can be more uniform when the modeling material forming the n+1-th layer is stacked on the n-th layer.

(5) In the aspect described above, in the data generation step, a first speed and a second speed may be set, the first speed being a moving speed of the ejection unit while the modeling material is stacked in the first region, the second speed being a moving speed of the ejection unit while the modeling material is stacked in the second region, and the first speed may be higher than the second speed.

According to the aspect, the decrease in the temperature of the first region can be suppressed until the modeling material is stacked in the entire first region of the n-th layer. Further, time can be gained for the temperature of the second region to decrease until the modeling material is stacked in the entire second region of the n-th layer.

(6) In the aspect described above, the temperature measurement step and the temperature prediction step may be executed, and the data generation step may include a first data generation step for generating the modeling data relating to the n+1-th layer, based on a prediction result of the temperature distribution of the n-th layer in the temperature prediction step, and a second data generation step for correcting the modeling data that is generated in the first data generation step and relates to the n+1-th layer, based on a measurement result of the temperature distribution of the n-th layer in the temperature measurement step.

According to the aspect, even when the temperature distribution of the n-th layer that is predicted in the temperature prediction step is different from the temperature distribution of the n-th layer that is measured in the temperature measurement step, a temperature of each part of the n-th layer can be more uniform when the modeling material forming the n+1-th layer is stacked on the n-th layer.

What is claimed is:

1. A method of manufacturing a three-dimensional modeling object, the method being executed to model a three-dimensional modeling object by ejecting a modeling material from an ejection unit of a three-dimensional modeling device and stacking a plurality of layers according to modeling data for modeling the three-dimensional modeling object layer by layer, the modeling data being generated based on shape data indicating a shape of the three-dimensional modeling object, the method comprising:
a first stacking step for stacking an n-th layer by ejecting the modeling material from the ejection unit, where n is a freely-selected integer equal to or greater than one;
at least one step of a temperature measurement step for measuring a temperature distribution of the n-th layer and a temperature prediction step for predicting a temperature distribution of the n-th layer;
a data generation step for generating or correcting the modeling data relating to an n+1-th layer, based on the temperature distribution of the n-th layer; and
a second stacking step for stacking the n+1-th layer by ejecting the modeling material from the ejection unit, based on the modeling data that is generated or corrected and relates to the n+1-th layer, wherein
the n-th layer includes a first region and a second region,
the first region is a region having a temperature lower than the second region, and
in the data generation step, the modeling data relating to the n+1-th layer is generated or corrected so that the modeling material is stacked in the first region before being stacked in the second region.

2. A method of manufacturing a three-dimensional modeling object according to claim 1, wherein
the n-th layer includes a plurality of first regions and the second region contacting with the plurality of first regions, and
in the data generation step, the modeling data relating to the n+1-th layer is generated or corrected so that the modeling material is stacked in the plurality of first regions without stopping ejection of the modeling material while allowing stacking of the modeling material on the second region.

3. A method of manufacturing a three-dimensional modeling object according to claim 1, wherein
the n-th layer includes a plurality of first regions, and
in the data generation step, the modeling data relating to the n+1-th layer is generated or corrected so that the modeling material is stacked in the second region after the modeling material is stacked in the plurality of first regions.

4. A method of manufacturing a three-dimensional modeling object according to claim 1, wherein
in the temperature measurement step, a temporal change of a temperature distribution of the n-th layer is measured,
in the temperature prediction step, a temporal change of a temperature distribution of the n-th layer is predicted,
the first region or the second region includes a third region and a fourth region,
the third region is a region having a temperature reduced more rapidly than the fourth region, and
in the data generation step, the modeling data relating to the n+1-th layer is generated or corrected based on the temporal change of the temperature distribution of the n-th layer so that the modeling material is stacked in the third region before being stacked in the fourth region.

5. A method of manufacturing a three-dimensional modeling object according to claim 1, wherein
in the data generation step, a first speed and a second speed are set, the first speed being a moving speed of the ejection unit while the modeling material is stacked in the first region, the second speed being a moving speed of the ejection unit while the modeling material is stacked in the second region, and
the first speed is higher than the second speed.

6. A method of manufacturing a three-dimensional modeling object according to claim 1, wherein
the temperature measurement step and the temperature prediction step are executed, and
the data generation step includes:
a first data generation step for generating the modeling data relating to the n+1-th layer, based on a prediction result of the temperature distribution of the n-th layer in the temperature prediction step; and
a second data generation step for correcting the modeling data that is generated in the first data generation step and relates to the n+1-th layer, based on a measurement result of the temperature distribution of the n-th layer in the temperature measurement step.
